(19) United States
(12) Patent Application Publication
(10) Pub. No.: US 2026/0088931 A1
(43) Pub. Date: Mar. 26, 2026

(54) METHOD AND APPARATUS FOR GENERATING CODE BLOCKS IN COMMUNICATION SYSTEM

(71) Applicant: ELECTRONICS AND TELECOMMUNICATIONS RESEARCH INSTITUTE, Daejeon (KR)

(72) Inventors: Giyoon PARK, Daejeon (KR); Seokki KIM, Daejeon (KR); Eun-Jeong SHIN, Daejeon (KR); Nam II KIM, Daejeon (KR)

(21) Appl. No.: 19/337,575

(22) Filed: Sep. 23, 2025

(30) Foreign Application Priority Data
Sep. 25, 2024 (KR) 10-2024-0129638

(51) Int. Cl. H04L 1/00

(52) U.S. Cl. CPC H04L 1/0057

(57) ABSTRACT

A method of a transmitter may comprise: generating a transport block; generating a plurality of first code blocks from the transport block; generating a plurality of second code blocks by encoding the plurality of first code blocks; generating byte-aligned third code blocks by selecting coded bits from encoded bits of each of the plurality of second code blocks; and concatenating the third code blocks.

### CROSS-REFERENCE TO RELATED APPLICATION

This application claims priority to Korean Patent Application No. 10-2024-0129638, filed on Sep. 25, 2024, with the Korean Intellectual Property Office (KIPO), the entire contents of which are hereby incorporated by reference.

### BACKGROUND

### 1. Technical Field

The present disclosure relates to a code block generation technique, and more particularly, to a technique for generating code blocks from encoded channel bits in a communication system.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In such a communication system, the development of modems using software has recently been carried out actively. Accordingly, the implementation of channel coding functions through software may also increase. In the channel coding process, the number of channel bits in one code block may not be divisible by 8. In such a case, due to the characteristics of a processor that operates in byte units, padding bits may be added to fill the last byte. Consequently, the removal of padding bits may be required when concatenating code blocks. As a result, the processor burden may increase as the data size grows.

### SUMMARY

The present disclosure for resolving the above-described problems is directed to providing methods and apparatuses for generating code blocks in a communication system, which generate code blocks from channel bits encoded in a low density parity check (LDPC) scheme.

According to a first exemplary embodiment of the present disclosure, a method of a transmitter may comprise: generating a transport block; generating a plurality of first code blocks from the transport block; generating a plurality of second code blocks by encoding the plurality of first code blocks; generating byte-aligned third code blocks by selecting coded bits from encoded bits of each of the plurality of second code blocks; and concatenating the third code blocks.

The generating of the plurality of second code blocks may comprise: performing low density parity check (LDPC) encoding on the plurality of first code blocks to generate the plurality of second code blocks.

The method may further comprise: before the generating of the plurality of second code blocks, adding cyclic redundancy check (CRC) parity bits to each of the plurality of first code blocks.

The generating of the byte-aligned third code blocks may comprise: selecting the coded bits based on at least one of a redundancy version index, a limited buffer rate matching (LBRM) index, or an LBRM transport block size.

The method may further comprise: after the generating of the byte-aligned third code blocks, interleaving bits of each of the plurality of third code blocks to generate an interleaved plurality of third code blocks.

The generating of the byte-aligned third code blocks may comprise: dividing G coded bits to make the third code blocks byte-aligned, wherein G is a positive integer.

The dividing of the G coded bits may comprise: calculating a temporary intermediate value N that is a divisor of G; calculating a multiplication factor u to make a multiple of an alignment unit M by multiplying the temporary intermediate value N; selecting γ₀ first base bits from the G coded bits and equally distributing the first base bits to C third code blocks; selecting γ₁ second base bits from first remaining bits obtained by subtracting the first base bits from the coded bits, and equally distributing the second base bits to code blocks having a non-dominant number of bits; and distributing second remaining bits obtained by subtracting the second base bits from the first remaining bits to a last third code block, wherein C is a number of the plurality of third code blocks and is a positive integer, and N, M, u, γ₀, and γ₁ are positive integers.

The calculating of the temporary intermediate value N may comprise: calculating the temporary intermediate value N as a product of a modulation order and a number of transmission layers to which the transport block is mapped.

The calculating of the multiplication factor u may comprise: calculating the multiplication factor u using M/gcd(M,N), where gcd is a greatest common divisor of two inputs.

C may be determined based on a code block group transmission information (CBGTI) field included in downlink control information (DCI), when the CBGTI field is present in the DCI.

The method may further comprise: transmitting at least one concatenated code block to a receiver.

According to a second exemplary embodiment of the present disclosure, a transmitter may comprise a processor, and the processor may cause the transmitter to perform: generating a transport block; generating a plurality of first code blocks from the transport block; generating a plurality of second code blocks by encoding the plurality of first code blocks; generating byte-aligned third code blocks by selecting coded bits from encoded bits of each of the plurality of second code blocks; and concatenating the third code blocks.

In the generating of the plurality of second code blocks, the processor may cause the transmitter to perform: performing low density parity check (LDPC) encoding on the plurality of first code blocks to generate the plurality of second code blocks.

The processor may further cause the transmitter to perform: before the generating of the plurality of second code blocks, adding cyclic redundancy check (CRC) parity bits to each of the plurality of first code blocks.

In the generating of the byte-aligned third code blocks, the processor may cause the transmitter to perform: selecting the coded bits based on at least one of a redundancy version index, a limited buffer rate matching (LBRM) index, or an LBRM transport block size.

The processor may further cause the transmitter to perform: after the generating of the byte-aligned third code blocks, interleaving bits of each of the plurality of third code blocks to generate an interleaved plurality of third code blocks.

In the generating of the byte-aligned third code blocks, the processor may cause the transmitter to perform: dividing G coded bits to make the third code blocks byte-aligned, wherein G is a positive integer.

In the dividing of the G coded bits, the processor may cause the transmitter to perform: calculating a temporary intermediate value N that is a divisor of G; calculating a multiplication factor u to make a multiple of an alignment unit M by multiplying the temporary intermediate value N; selecting γ₀ first base bits from the G coded bits and equally distributing the first base bits to C third code blocks; selecting γ₁ second base bits from first remaining bits obtained by subtracting the first base bits from the coded bits, and equally distributing the second base bits to code blocks having a non-dominant number of bits; and distributing second remaining bits obtained by subtracting the second base bits from the first remaining bits to a last third code block, wherein C is a number of the plurality of third code blocks and is a positive integer, and N, M, u, γ₀, and γ₁ are positive integers.

In the calculating of the temporary intermediate value N, the processor may cause the transmitter to perform: calculating the temporary intermediate value N as a product of a modulation order and a number of transmission layers to which the transport block is mapped.

In the calculating of the multiplication factor u, the processor may cause the transmitter to perform: calculating the multiplication factor u using M/gcd(M,N), where gcd is a greatest common divisor of two inputs.

According to the present disclosure, a transmitter can generate code blocks by dividing coded bits so that the code blocks are byte-aligned. In addition, according to the present disclosure, the transmitter can minimize an operation of removing padding bits in a process of concatenating the code blocks. Furthermore, according to the present disclosure, the transmitter can appropriately cope with an increase in burden due to large data sizes by minimizing the operation of removing the padding bits in the process of concatenating the code blocks.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment in which division of channel bits is not byte aligned.

FIG. 4 is a block diagram illustrating a first exemplary embodiment of an uplink or downlink transmission and reception coding chain.

FIG. 5 is a flowchart illustrating a first exemplary embodiment of a method of selecting coded bits per code block by applying byte alignment.

FIG. 6 is a conceptual diagram illustrating a first exemplary embodiment of contributions of an integer intermediate value, a number of code blocks having a non-dominant number of bits, and a number of padding bits to an area that is divided.

FIG. 7 is a conceptual diagram illustrating a second exemplary embodiment of contributions of an integer intermediate value, a number of code blocks having a non-dominant number of bits, and a number of padding bits to an area that is divided.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

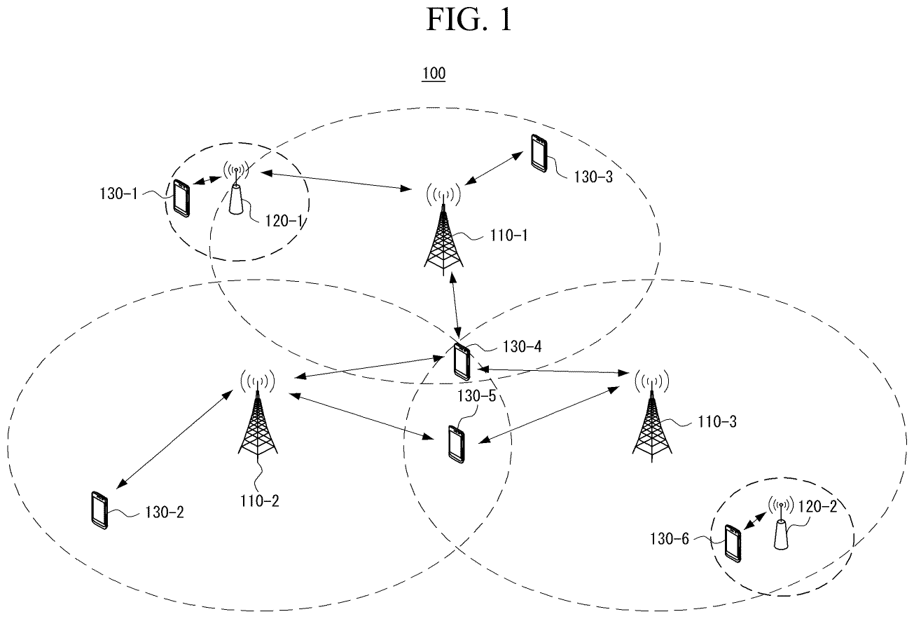

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’.

Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

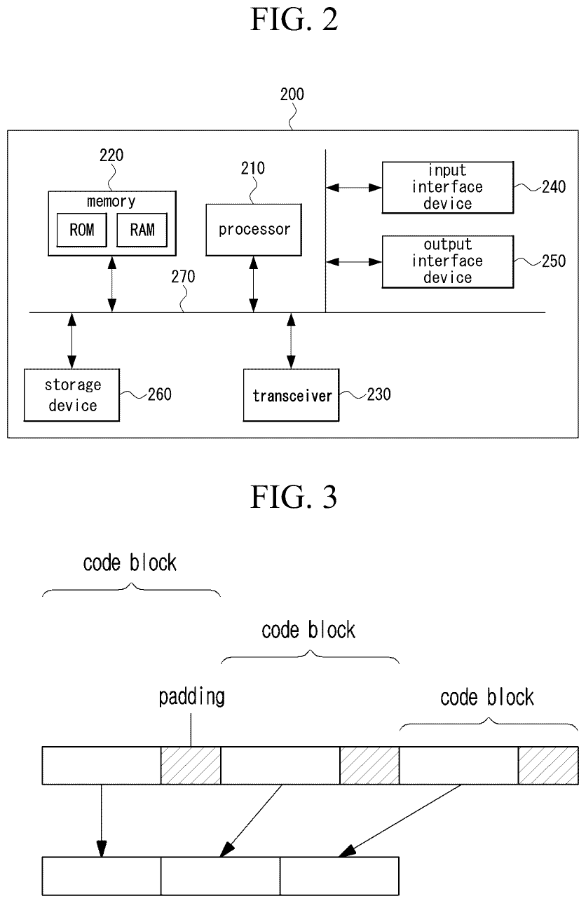

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to the cell coverage of the first base station 110-1. Also, the second UE 130-2, the fourth UE 130-4, and the fifth UE 130-5 may belong to the cell coverage of the second base station 110-2. Also, the fifth base station 120-2, the fourth UE 130-4, the fifth UE 130-5, and the sixth UE 130-6 may belong to the cell coverage of the third base station 110-3. Also, the first UE 130-1 may belong to the cell coverage of the fourth base station 120-1, and the sixth UE 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of UE 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding UE 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, in applying channel coding techniques in wireless communication, the scale of information bits to be transmitted and available channel bits may increase. In such a case, a processor may divide channel bits into a plurality of code blocks and perform encoding. Due to such division of channel bits, a theoretical coding gain may be lost. However, a communication system can facilitate code design by limiting the number of information bits and channel bits, and can reduce delay time in a transmission and reception process.

Recently, developments of software-based modems are actively underway. Accordingly, channel encoding functions may also increasingly be implemented in software. The number of channel bits belonging to one code block may not be divisible by 8. In such a case, padding bits may be added to fill the last byte due to the characteristic of a processor that processes in byte units. Accordingly, removal of padding bits may be required in a process of concatenating code blocks. As a result, as data increases in size, the burden on the processor may further increase.

FIG. 3 is a conceptual diagram illustrating a first exemplary embodiment in which division of channel bits is not byte aligned.

Referring to FIG. 3, a transmitter may divide channel bits to generate code blocks. In this case, the number of channel bits belonging to a code block may not be divisible by 8. In such a case, the transmitter may add padding bits at the end of each code block. In such a situation, the transmitter may concatenate the code blocks after removing the padding bits.

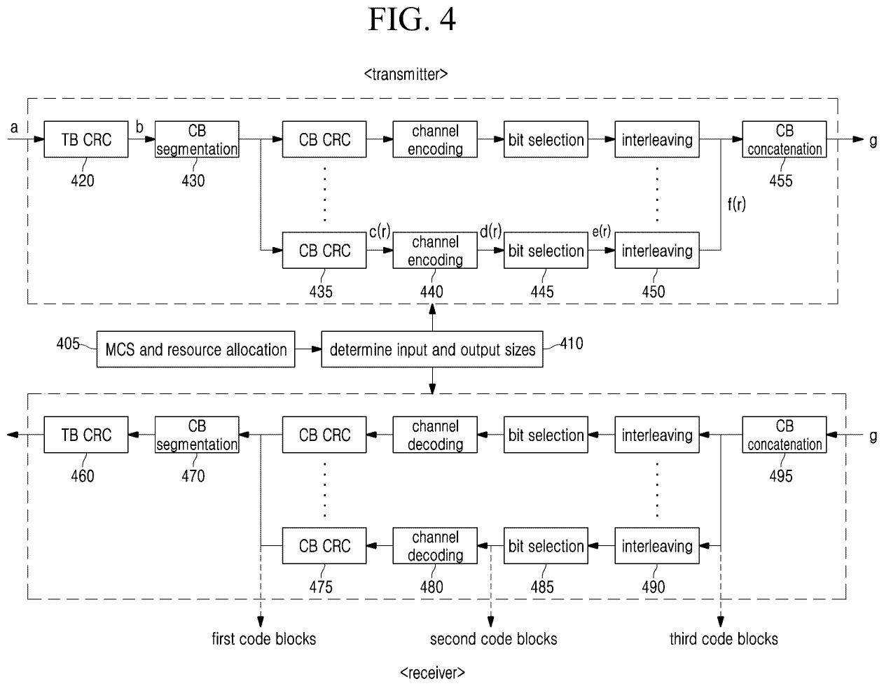

FIG. 4 is a block diagram illustrating a first exemplary embodiment of an uplink or downlink transmission and reception coding chain.

Referring to FIG. 4, coding may be used for transmission of data payloads in a wireless network such as a physical uplink shared channel (PUSCH) or a physical downlink shared channel (PDSCH). The operations of FIG. 4 may be performed by a transmitter such as a terminal or a base station. A coding chain may be at least partially based on a modulation and coding scheme (MCS) and radio resource allocation information 405. The MCS may be an index indicating a code rate and a modulation order for communication. For example, the MCS may indicate how many bits per resource element (RE) can be transmitted. The modulation order may indicate the number of bits per RE (parity bits or information bits), and the code rate may indicate a ratio between information bits for encoding and parity bits. Generally, the MCS may be indicated through scheduling information for given communication, such as downlink control information (DCI). In addition, the radio resource allocation information may include the number of REs available for message transmission.

The transmitter and a receiver may determine a transport block size (TBS) (410), the number of code blocks, and the sizes of code blocks at least partially based on the MCS. The TBS may indicate how many bits are delivered from a medium access control (MAC) layer to a physical layer in one instance of uplink shared channel transmission that may span one or more slots. For example, in a PUSCH or a PDSCH, a payload for the physical layer may be a transport block (TB). The TB may include a certain number of bits determined based at least in part on the MCS and the number of physical resource blocks (PRBs) used to transmit the TB.

The transmitter may generate a transport block a (415). Here, the transport block a may include a certain number of bits indicated by the TBS of the TB. The transmitter may append cyclic redundancy check (CRC) bits to the TB to form a transport block b. The CRC bits may assist error detection. The CRC bits may be generated using a cyclic generator polynomial and may be appended at the end of the TB.

The transmitter may determine a base graph (BG) for the transport block b (425). The BG may include parameters for determining parity bits for transmission at least partially based on the TBS and the code rate. A BG1 may be for TBs having a larger TBS, and a BG2 may be for TBs having a smaller TBS.

The transmitter may perform code block (CB) segmentation 430 for the TB b. ‘CB segmentation’ may refer to segmentation of the TB to form one or more code blocks for channel coding and rate matching. Each code block may be individually encoded. For example, operations illustrated as reference numerals 435 to 450 may be performed for each individual code block among the one or more code blocks.

The transmitter may append one or more CRCs to one or more code blocks to form code block(s) c(r) (435). Here, a block index r may be a positive integer, and c(r) may indicate a bit block. For example, the transmitter may perform code block-wise CRC determination and insertion for one or more code blocks c(r), which can assist in early error detection. The transmitter may perform low density parity check (LDPC) encoding 440 for one or more code blocks to form encoded bits d(r). Here, d(r) may indicate a bit block. More generally, the transmitter may perform channel coding according to one or more parameters such as the determined BG. The LDPC encoding may generate a plurality of encoded bits d(r) stored in a circular buffer. In some aspects, the encoded bits may be referred to as encoded code blocks. The encoded bits d(r) may be distinct from the code blocks c(r).

Depending on a scheme of rate matching, all encoded bits generated by LDPC coding may be transmittable or only a portion thereof may be transmittable. However, in 5G NR, among bits corresponding to an information word or a code block, the first 2×Z bits (Z: lifting size) may not always be transmitted regardless of rate matching. In certain other communication systems, the first 2×Z bits may be transmitted partially or entirely, and may be selected or excluded according to rate matching.

The scheme of processing all encoded bits generated by LDPC coding to be deliverable may be referred to as full buffer rate matching (FBRM), and the scheme of limiting the number of transmittable encoded bits may be referred to as limited buffer rate matching (LBRM). When resources are allocated for data transmission, LDPC encoder outputs may be input to a circular buffer, and the bits of the buffer may be repeatedly transmitted as much as the allocated resources.

The transmitter may perform bit selection 445. ‘Bit selection’ may refer to selecting coded bits e(r) (sometimes referred to as encoded bits) (the entirety of selected coded bits indicated as E) for interleaving and concatenation. For example, the coded bits e(r) may be selected from the encoded bits d(r). The bit selection may be at least partially based on a redundancy version index rv_{id}, an LBRM index I_{LBRM}, and an LBRM transport block size TBS_{LBRM}. Here, e(r) and rv_{id} may be positive real numbers. id may be a positive integer.

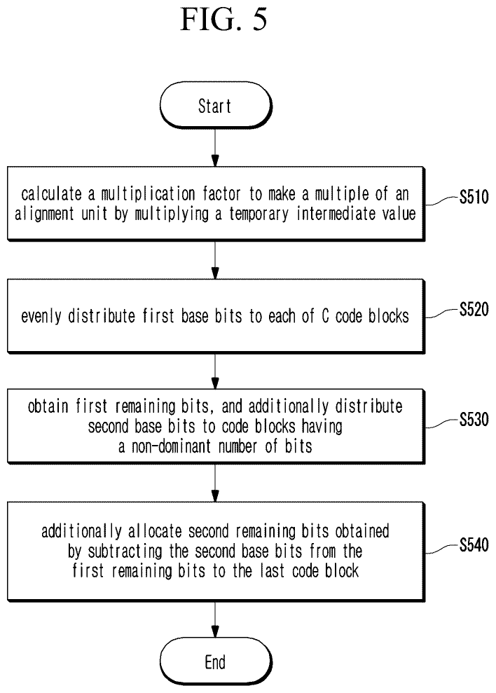

For such bit selection, the transmitter may select the number of coded bits per code block by applying byte alignment. Such a process in which the transmitter applies byte alignment to select the number of coded bits per code block may be described in detail with reference to FIG. 5.

Meanwhile, the number of coded bits to be transmitted in a specific transmission (e.g. a slot, a PUSCH) for a code block index r may be denoted as Er. Here, r and Er may be non-negative integers. Code blocks may be aligned to RE boundaries (e.g. a single RE carrying a specific modulation symbol may include only bits corresponding to a single code block).

G may represent the number of actual bits available for transmission (e.g. a total number of coded bits available for transmission of a transport block) for a single-slot transmission (i.e. a transmission opportunity occupying only one slot). C′ may represent the number of code blocks to be transmitted, where C′ may follow a code block group transmission information (CBGTI) field in DCI if the CBGTI field is present in the DCI. Alternatively, C′ may be C (i.e. all code blocks) if the CBGTI field is not present. Bits may be sequentially selected (e.g. read) from the circular buffer. Here, G, C, and C′ may be positive integers.

A starting position k₀ for a code block may be determined by a redundancy version (RV). In the case of segment-based rate matching or slot-based rate matching, the starting position may be determined at least partially based on stored information such as a last position from which the transmitter has read bits for a previous slot or segment. For a given encoded bit sequence e(r), the number of bits read may be Er excluding filler bits.

When slot-based rate matching is used, G may be defined as the number of actual transmission bits available per slot, and Er may be defined as the number of coded bits of the r-th code block to be transmitted in a given slot. When segment-based rate matching is used, G may be defined as the number of actual transmission bits available per segment, and Er may be defined as the number of coded bits of the r-th code block to be transmitted in a given segment.

The transmitter may perform interleaving 450 to generate one or more interleaved encoded bit sequences f(r). Here, f(r) may indicate a bit block. The interleaving may be performed on a code block basis (for each code block e(r)). In some cases, ‘interleaving’ may be referred to as ‘channel interleaving’. In some aspects, the transmitter may perform row-column interleaving. In row-column interleaving, selected bits may be arranged into a plurality of rows corresponding to a modulation order. Then, the selected bits may be read column-by-column such that bits from respective rows are interleaved with each other. In the case of redundancy version 0, the interleaver may be a system-bit priority interleaver so that system bits may be placed at higher reliability positions in quadrature amplitude modulation (QAM) symbols.

When binary phase shift keying (BPSK) is used, the interleaver may not affect a bit stream. The transmitter may perform code block concatenation for encoded bit sequences f(r) to generate a code block g (distinct from code block(s) e(r)) 455. After the code block is generated, the transmitter may transmit the code block. For example, the transmitter may perform scrambling, modulation, layer mapping, antenna port mapping, mapping to one or more virtual resource blocks (VRBs), and mapping from the VRBs to PRBs. Then, the transmitter may transmit an encoded transport block at least partially based on the code block.

The receiver may receive the encoded transport block through time-frequency resources allocated for such a transmission opportunity. For example, in a multi-slot transmission opportunity, the receiver may receive communication including interleaved encoded bit sequences of one or more code blocks. The receiver may estimate a channel using demodulation reference signals transmitted with the encoded bits.

By using the estimated channel and the received signal, the receiver may perform demapping operations for each RE of the received signal to obtain soft information on bit values of the encoded transport block. For example, the receiver may demap the code block to obtain soft information for each of a plurality of transmitted bits. The soft information may take a form of a log-likelihood ratio (e.g. a probability that a transmitted bit is 0 or 1 based on the received signal). Such probabilities may be quantized into several levels (e.g. 16 or 32 levels).

In an extreme case where a probability is quantized into two levels, the soft information may degenerate into ‘hard’ information. For example, two-level quantization of probabilities may represent the receiver's best guess about what the transmitted bit is, without any additional nuance about the guess. The receiver may perform de-interleaving on the soft information to obtain de-interleaved soft information.

For example, to obtain de-interleaved soft information, the receiver may de-interleave the soft information on a slot basis for each of a plurality of slots, or on a segment basis for each of a plurality of segments. In this case, each segment may include one of one or more sets of adjacent u=M/gcd(M,N) time domain resources and may span at least two slots.

The receiver may concatenate the de-interleaved soft information to obtain concatenated soft information. The receiver may decode the concatenated soft information to infer one or more code blocks of the communication. For example, the receiver may decode the transmitted bits based on the concatenated soft information presented as input to a decoder. A decoding block may partition the concatenated soft information to identify soft information associated with each encoded code block. Then, each such partition may be used to decode actual transmitted bits corresponding to that code block.

FIG. 5 is a flowchart illustrating a first exemplary embodiment of a method of selecting coded bits per code block by applying byte alignment. The method may be performed in the block 410 or 445 of FIG. 4.

Referring to FIG. 5, the transmitter may calculate a multiplication factor u to make a multiple N of an alignment unit M by multiplying a temporary intermediate value N as shown in Equation 1 (S510). In the case of byte alignment, M may be set to 8. The transmitter may calculate the temporary intermediate value N, which is a divisor of G, together with the number of code blocks C, depending on the length of a transport block and the MCS. Accordingly, N may be a multiple of M (N̅=N·u). Here, C, G, N, and M may be positive integers.

$$u = M / gcd ( M , N ) \qquad [ Equation 1 ]$$

Here, gcd may refer to the greatest common divisor of two input positive integers. Here, the temporary intermediate value N may be calculated as a product of the modulation order Qₘ and the number of transmission layers N_{L} to which the transport block is mapped. For example, the temporary intermediate value N may be 6 if the modulation order Qₘ is 6 and the number of transmission layers N_{L} is 1. In this case, if the alignment unit M is, as one example, 8, the multiplication factor may be u=4. Here, the modulation order and the number of transmission layers may be positive integers.

The transmitter may select first base bits using Equation 2. Then, the transmitter may evenly distribute the first base bits to each of the C code blocks.

$${γ}_{0} = C \overline{N} \cdot ⌊ \frac{G}{C \overline{N}} ⌋ \qquad [ Equation 2 ]$$

In other words, the transmitter may evenly distribute the first base bits in units of N

$$\overline{N} \cdot ⌊ \frac{G}{C \overline{N}} ⌋$$

bits to C code blocks (S520). Next, after calculating first remaining bits obtained by subtracting the first base bits from total bits G to be transmitted using Equation 3, the transmitter may additionally distribute selected second base bits γ₁ in units of N bits to code blocks having a non-dominant number

$$⌊ \frac{( G - {γ}_{0} )}{\overline{N}} ⌋$$

of bits using Equation 4 (S530). Here, the floor function (└ ┘) may be a function that returns an integer value by rounding down a fractional part when a specified value has a fractional part.

$$G - {γ}_{0} = mod ( G , C \overline{N} ) \qquad [ Equation 3 ]$$

$${γ}_{1} = \overline{N} \cdot ⌊ \frac{( G - {γ}_{0} )}{\overline{N}} ⌋ \qquad [ Equation 4 ]$$

The transmitter may additionally allocate second remaining bits, which are calculated by subtracting the second base bits from the first remaining bits as in Equation 5, to the last code block (S540). mod( ) may be a mathematical modulo function that returns a non-negative remainder of integer division. A first argument may be a dividend and a second argument may be a divisor, and both arguments may be integer values.

$${γ}_{2} = G - {γ}_{0} - {γ}_{1} = mod ( G , \overline{N} ) \qquad [ Equation 5 ]$$

Through the above processes, code blocks except for the last code block may have a number of bits that is a multiple of N.

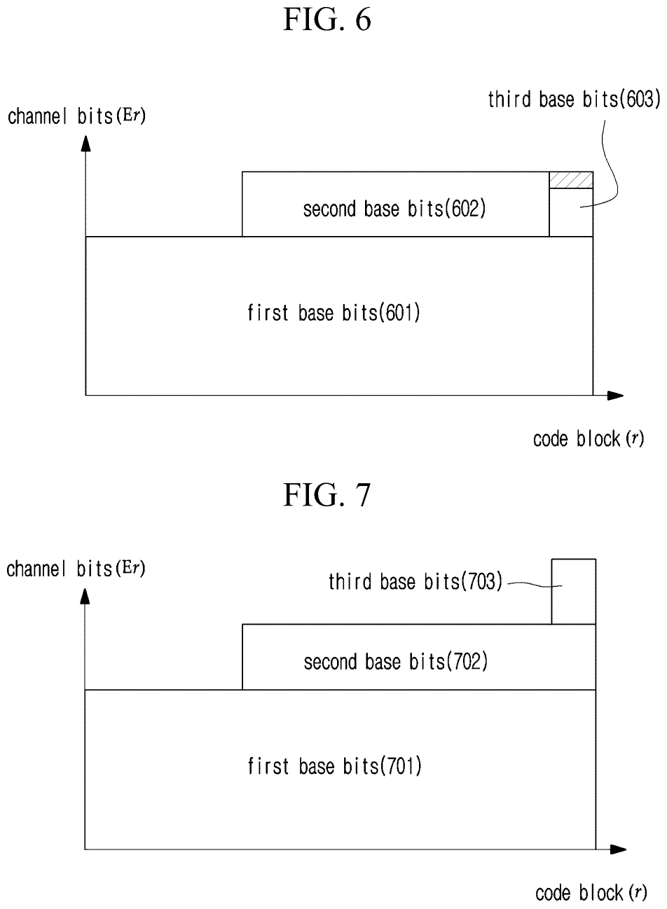

FIG. 6 is a conceptual diagram illustrating a first exemplary embodiment of contributions of an integer intermediate value, a number of code blocks having a non-dominant number of bits, and a number of padding bits to an area that is divided.

Referring to FIG. 6, 601 to 603 may indicate how first to third base bits are placed in code blocks. Second and third base bits have a characteristic of not overlapping.

Referring again to FIG. 5, the transmitter may calculate a number of bits per code block using Equation 6 below based on the integer intermediate value, the number of code blocks having a non-dominant number of bits, and the number of padding bits.

$${E}_{r} = \{ \begin{matrix}\overline{N} \cdot ⌊ \frac{G}{C \overline{N}} ⌋ if r \leq C - mod ( ⌈ \frac{G}{\overline{N}} ⌉ , C ) - 1 \\ \overline{N} \cdot ⌊ \frac{G}{C \overline{N}} ⌋ else if r \leq C - 2 or mod ( G , \overline{N} ) = 0 \\ \overline{N} \cdot ⌊ \frac{G}{C \overline{N}} ⌋ + mod ( G , \overline{N} ) , otherwise\end{matrix} \qquad [ Equation 6 ]$$

For example, when byte alignment is not configured, u=1 may be used, and encoded channel bits may be divided into E=(870, 870, 870, 876, 876) bits. On the other hand, when byte alignment is configured, u=4 may be used, and encoded channel bits may be divided into E=(864, 864, 864, 888, 882) bits so that the preceding four blocks may become multiples of 8. Here, a ceil function (┌ ┐) may be a function that always rounds up a specified value with a fractional part to return a next integer value.

FIG. 7 is a conceptual diagram illustrating a second exemplary embodiment of contributions of an integer intermediate value, a number of code blocks having a non-dominant number of bits, and a number of padding bits to an area that is divided.

Referring to FIG. 7, another example in which base bits are placed in code blocks is illustrated. 701 to 703 may indicate how first to third base bits are placed in code blocks. A characteristic exists in which the first to third base bits overlap in the last code block. In this case, a result corresponding to Equation 7 is obtained.

$${E}_{r} = \{ \begin{matrix}\overline{N} \cdot ⌊ \frac{G}{C \overline{N}} ⌋ if r \leq C - mod ( ⌈ \frac{G}{\overline{N}} ⌉ , C ) - 1 \\ \overline{N} \cdot ⌊ \frac{G}{C \overline{N}} ⌋ else if r \leq C - 2 \\ \overline{N} \cdot ⌊ \frac{G}{C \overline{N}} ⌋ + mod ( G , \overline{N} ) , otherwise\end{matrix} \qquad [ Equation 7 ]$$

When a CBGTI exists, Equation 6 and Equation 7 are limitedly applied to code blocks to be transmitted. That is, a number C of code blocks is replaced with a number C′ of scheduled code blocks, and a code block index r also takes a value equal to or greater than 0 and less than C′.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a transmitter, comprising:
generating a transport block;
generating a plurality of first code blocks from the transport block;
generating a plurality of second code blocks by encoding the plurality of first code blocks;
generating byte-aligned third code blocks by selecting coded bits from encoded bits of each of the plurality of second code blocks; and
concatenating the third code blocks.

2. The method of claim 1, wherein the generating of the plurality of second code blocks comprises: performing low density parity check (LDPC) encoding on the plurality of first code blocks to generate the plurality of second code blocks.

3. The method of claim 1, further comprising: before the generating of the plurality of second code blocks, adding cyclic redundancy check (CRC) parity bits to each of the plurality of first code blocks.

4. The method of claim 1, wherein the generating of the byte-aligned third code blocks comprises: selecting the coded bits based on at least one of a redundancy version index, a limited buffer rate matching (LBRM) index, or an LBRM transport block size.

5. The method of claim 1, further comprising: after the generating of the byte-aligned third code blocks, interleaving bits of each of the plurality of third code blocks to generate an interleaved plurality of third code blocks.

6. The method of claim 1, wherein the generating of the byte-aligned third code blocks comprises: dividing G coded bits to make the third code blocks byte-aligned, wherein G is a positive integer.

7. The method of claim 6, wherein the dividing of the G coded bits comprises:
calculating a temporary intermediate value N that is a divisor of G;
calculating a multiplication factor u to make a multiple of an alignment unit M by multiplying the temporary intermediate value N;
selecting γ₀ first base bits from the G coded bits and equally distributing the first base bits to C third code blocks;
selecting γ₁ second base bits from first remaining bits obtained by subtracting the first base bits from the coded bits, and equally distributing the second base bits to code blocks having a non-dominant number of bits; and
distributing second remaining bits obtained by subtracting the second base bits from the first remaining bits to a last third code block,
wherein C is a number of the plurality of third code blocks and is a positive integer, and N, M, u, γ₀, and γ₁ are positive integers.

8. The method of claim 7, wherein the calculating of the temporary intermediate value N comprises: calculating the temporary intermediate value N as a product of a modulation order and a number of transmission layers to which the transport block is mapped.

9. The method of claim 7, wherein the calculating of the multiplication factor u comprises: calculating the multiplication factor u using M/gcd(M,N), where gcd is a greatest common divisor of two inputs.

10. The method of claim 7, wherein C is determined based on a code block group transmission information (CBGTI) field included in downlink control information (DCI), when the CBGTI field is present in the DCI.

11. The method of claim 1, further comprising: transmitting at least one concatenated code block to a receiver.

12. A transmitter comprising a processor, wherein the processor causes the transmitter to perform:
generating a transport block;
generating a plurality of first code blocks from the transport block;
generating a plurality of second code blocks by encoding the plurality of first code blocks;
generating byte-aligned third code blocks by selecting coded bits from encoded bits of each of the plurality of second code blocks; and
concatenating the third code blocks.

13. The transmitter of claim 12, wherein in the generating of the plurality of second code blocks, the processor causes the transmitter to perform: performing low density parity check (LDPC) encoding on the plurality of first code blocks to generate the plurality of second code blocks.

14. The transmitter of claim 12, wherein the processor further causes the transmitter to perform: before the generating of the plurality of second code blocks, adding cyclic redundancy check (CRC) parity bits to each of the plurality of first code blocks.

15. The transmitter of claim 12, wherein in the generating of the byte-aligned third code blocks, the processor causes the transmitter to perform: selecting the coded bits based on at least one of a redundancy version index, a limited buffer rate matching (LBRM) index, or an LBRM transport block size.

16. The transmitter of claim 12, wherein the processor further causes the transmitter to perform: after the generating of the byte-aligned third code blocks, interleaving bits of each of the plurality of third code blocks to generate an interleaved plurality of third code blocks.

17. The transmitter of claim 12, wherein in the generating of the byte-aligned third code blocks, the processor causes the transmitter to perform: dividing G coded bits to make the third code blocks byte-aligned, wherein G is a positive integer.

18. The transmitter of claim 12, wherein in the dividing of the G coded bits, the processor causes the transmitter to perform:
calculating a temporary intermediate value N that is a divisor of G;
calculating a multiplication factor u to make a multiple of an alignment unit M by multiplying the temporary intermediate value N;
selecting γ₀ first base bits from the G coded bits and equally distributing the first base bits to C third code blocks;
selecting γ₁ second base bits from first remaining bits obtained by subtracting the first base bits from the coded bits, and equally distributing the second base bits to code blocks having a non-dominant number of bits; and
distributing second remaining bits obtained by subtracting the second base bits from the first remaining bits to a last third code block,
wherein C is a number of the plurality of third code blocks and is a positive integer, and N, M, u, γ₀, and γ₁ are positive integers.

19. The transmitter of claim 18, wherein in the calculating of the temporary intermediate value N, the processor causes the transmitter to perform: calculating the temporary intermediate value N as a product of a modulation order and a number of transmission layers to which the transport block is mapped.

20. The transmitter of claim 18, wherein in the calculating of the multiplication factor u, the processor causes the transmitter to perform: calculating the multiplication factor u using M/gcd(M,N), where gcd is a greatest common divisor of two inputs.
